(19) United States
(12) Patent Application Publication
(10) Pub. No.: US 2021/0195713 A1
(43) Pub. Date: Jun. 24, 2021

(54) LOCATION BASED LIGHTING EXPERIENCE

(71) Applicant: L'Oreal, Paris (FR)

(72) Inventor: Lily Truong, Redmond, WA (US)

(73) Assignee: L'Oreal, Paris (FR)

(21) Appl. No.: 16/719,410

(22) Filed: Dec. 18, 2019

(51) Int. Cl. H05B 47/11; H05B 45/20; H05B 45/10; G09B 19/00; G06Q 30/06; G06Q 30/02; A45D 33/00; A45D 44/00; A46B 15/00

(52) U.S. Cl. CPC H05B 47/11; H05B 45/20; H05B 45/10; G09B 19/0023; G06Q 30/0631; A45D 42/04; A45D 33/008; A45D 44/005; A46B 15/0055; A46B 15/0036; G06Q 30/0203

(57) ABSTRACT

A lighting system device includes a light sensor to measure ambient lighting conditions; a light source; one or more computing devices allowing selecting a location other than ambient location; one or more computing devices that compare the ambient lighting conditions to the lighting conditions of the selected location; and one or more computing devices that control the output of the light source to produce lighting conditions that when combined with the ambient lighting conditions simulate the lighting conditions of the selected location.

### SUMMARY

A simulated lighting experience is created artificially based on a user's location. A lighting system can be embodied in a carried accessory, such as cosmetic compact case, a make-up brush, or a mirror having a computer system with network connectivity. In one embodiment, the lighting system connects to a server computing system that stores a plurality of light conditions. Light usually affects the way cosmetics and make-up are perceived by the user and observers. Generally, a user does not apply cosmetics or make-up under lighting conditions that are similar to the lighting conditions in which a user will be present. For example, most users apply cosmetics or make-up in the home. However, the user usually steps out of the home to entertainment venues, such as restaurants, bars, music venues, theatres, and the like. The lighting parameters of the home are not similar to the lighting conditions in these entertainment venues, therefore, the user will not know how or whether the cosmetics and make-up will appear similar to an observer as it did to the user in the home Once the user arrives at the destination, the user may have to touch-up or reapply more or a different make-up cosmetic.

In one embodiment, the lighting system has a sensor to measure the lighting parameters at the time and place of applying make-up, then, the user may select the lighting of a destination, and the light system will automatically adjust the light output to resemble the lighting of the destination, thus creating simulated lighting conditions so that the user can see more accurately how the make-up will appear at the destination.

In one embodiment, a lighting system device comprises: a light sensor to measure ambient lighting conditions; a light source; one or more computing devices allowing selecting a location other than ambient location; one or more computing devices that compare the ambient lighting conditions to the lighting conditions of the selected location; and one or more computing devices that control the output of the light source to produce lighting conditions that when combined with the ambient lighting conditions simulate the lighting conditions of the selected location.

In one embodiment of the lighting system device, the lighting conditions include one of light temperature, light color rendering index, and light diffusion;

In one embodiment, the lighting system device further comprises a mirror, a brush, or a compact case.

In one embodiment of the lighting system device, the light source includes one or more light emitting diodes.

In one embodiment, the lighting system device further comprises a communications module.

In one embodiment of the lighting system device, the location is selected from at least one of indoor, outdoor, day, night, stage, non-stage, an entertainment venue.

In one embodiment, a computer-implemented method of simulating lighting conditions comprises: receiving, by the computing device, a selection for a location; receiving, by a computing device, measured ambient lighting conditions; receiving, by the computing device, lighting conditions of the selected location; and providing, by the computing device, instructions for a lighting system device, wherein the instructions control a light source to output light that when combined with the ambient lighting conditions simulate the lighting conditions of the selected location.

In one embodiment of the computer-implemented method, the instructions control at least one of light temperature, light color rendering index, and light diffusion.

In one embodiment, the computer-implemented method further comprises providing, by the computing device, a comparison of the measured ambient lighting conditions to the lighting conditions of the selected location.

In one embodiment, the computer-implemented method further comprises providing, by the computing device, cosmetic make-up recommendations that are best suited for the measured ambient lighting conditions.

In one embodiment, the computer-implemented method further comprises providing, by the computing device, cosmetic make-up recommendations that are best suited for the lighting conditions of the selected location.

In one embodiment, a computing device, comprising at least a memory and processor, is configured to: receive a selection of a location; receive measured ambient lighting conditions; receive lighting conditions of the selected location; and provide instructions for a lighting system device, wherein the instructions control a light source to output light that when combined with the ambient lighting conditions simulate the lighting conditions of the selected location.

In one embodiment of the computing device, the instructions control at least one of light temperature, light color rendering index, and light diffusion.

In one embodiment of the computing device, the computing device is further configured to compare the measured ambient lighting conditions to the lighting conditions of the selected location.

In one embodiment of the computing device, the computing device is further configured to provide cosmetic make-up recommendations that are best suited for the measured ambient lighting conditions.

In one embodiment of the computing device, the computing device is further configured to provide cosmetic make-up recommendations that are best suited for the lighting conditions of the selected location.

In one embodiment, the computing device comprises an application programming interface to retrieve the lighting conditions.

In one embodiment, a system comprises: a questionnaire analysis engine including computational circuitry configured to provide a selection of a location; a light analysis engine including computational circuitry configured to receive measured ambient lighting conditions and lighting conditions of the selected location; and an instruction engine including computational circuitry configured to provide instructions for a lighting system device, wherein the instructions control a light source to output light that when combined with the ambient lighting conditions simulate the lighting conditions of the selected location.

In one embodiment of the system, the instructions control at least one of light temperature, light color rendering index, and light diffusion.

In one embodiment of the system, the light analysis engine includes computational circuitry configured to compare the measured ambient lighting conditions to the lighting conditions of the selected location.

In one embodiment, the system further comprises a recommendation engine including computational circuitry configured to provide cosmetic make-up recommendations that are best suited for the measured ambient lighting conditions.

In one embodiment, the system further comprises a recommendation engine including computational circuitry configured to provide cosmetic make-up recommendations that are best suited for the lighting conditions of the selected location.

In one embodiment, the system comprises an application programming interface to retrieve the lighting conditions.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of an electric reciprocating brow ink device in accordance with one embodiment of this disclosure;

FIG. 2 is a diagrammatical illustration of an electric oscillating brow ink device in accordance with one embodiment of this disclosure;

FIG. 3 is a diagrammatical illustration of an electric oscillating brow ink device in accordance with one embodiment of this disclosure; and

FIG. 4 is a block diagram that illustrates a non-limiting example embodiment of a system that includes a mobile computing device and a server computing system according to various aspects of the present disclosure.

### DETAILED DESCRIPTION

The disclosure is related to devices and methods for creating a simulated lighting environment based on the location.

A simulated lighting experience is created artificially based on a user's location. A lighting system can be embodied in a carried accessory, such as cosmetic compact case, a make-up brush, or a mirror having a computer system with network connectivity. In one embodiment, the lighting system connects to a server computing system that stores a plurality of light conditions. Light usually affects the way cosmetics and make-up are perceived by the user and observers. Generally, a user does not apply cosmetics or make-up under lighting conditions that are similar to the lighting conditions in which a user will be present. For example, most users apply cosmetics or make-up in the home. However, the user usually steps out of the home to entertainment venues, such as restaurants, bars, music venues, theatres, and the like. The lighting parameters of the home are not similar to the lighting conditions in these entertainment venues, therefore, the user will not know how or whether the cosmetics and make-up will appear similar to an observer as it did to the user in the home. Once the user arrives at the destination, the user may check their make-up again, and may further touch-up the make-up based on the lighting conditions after the user has arrived at the destination.

In one embodiment, it would be useful to simulate lighting conditions so that a user can properly see how make-up will appear before the user has arrived at the desired destination rather than trying to touch-up or correct the make-up after having arrived.

In one embodiment, a lighting system has a sensor to measure the lighting parameters at the time and place of applying make-up, then, the user may select the lighting conditions of a destination, and the lighting system will automatically adjust the light output of the lighting system to resemble the lighting conditions of the selected destination, thus simulating the lighting conditions so that the user can see more accurately how make-up will appear at the destination, while not being physically present at the destination.

In one embodiment, a lighting system includes one or more light sensors. Light sensors include, but, are not limited to any type of photoelectric devices that can detect at least one of the light temperature, light color rendering index, and light diffusion. In one embodiment, light temperature is measured in degrees Kelvin which represents the radiation emitted when a “black body radiator” is at the temperature. In one embodiment, light color rendering index can be defined by a number from 0 to 100 that indicates how well a light source is a rendering color in comparison to a reference light source, such as daylight, or how well a light source will make the colors appear to humans. In one embodiment, light diffusion can be a combination of measuring the absorption, transmission, and reflection of light.

This disclosure relates to devices and methods that can measure the one or more light properties of ambient light and adjust a light source so that the perceived light has one or more of a selected light source.

In one embodiment, the simulated lighting conditions can be specified generically, such as indoor versus outdoor, day versus night, stage versus non-stage lighting, etc. In one embodiment, the light parameters of each of these different lighting conditions is stored either on the lighting system device itself or on a server computing system, and the lighting conditions are communicated to the lighting system device.

In one embodiment, the lighting system includes sensors that measure the one or more lighting parameters, temperature, color rendering index, and diffusion. In one embodiment, the lighting system includes a light source, such a light emitting diodes. In one embodiment, the light emitting diodes are capable of producing lighting conditions ranging across of the full scale of each of the parameters, temperature, color rendering index, and diffusion.

In one embodiment, once the sensors are able to determine the light temperature, color rendering index, and diffusion, the lighting system device will be able to calculate the output of the light emitting diodes in order to reproduce a simulated lighting environment that has been selected by the user of the lighting system device.

The lighting system device can be embodied in various products. In one embodiment, the lighting system is embodied in a product that can fit into a carried accessory, such as a purse, wallet, handbag, or a suitcase. In one embodiment, the lighting system is embodied in a more permanent fixture, such as a bathroom vanity mirror or a full-length wardrobe mirror.

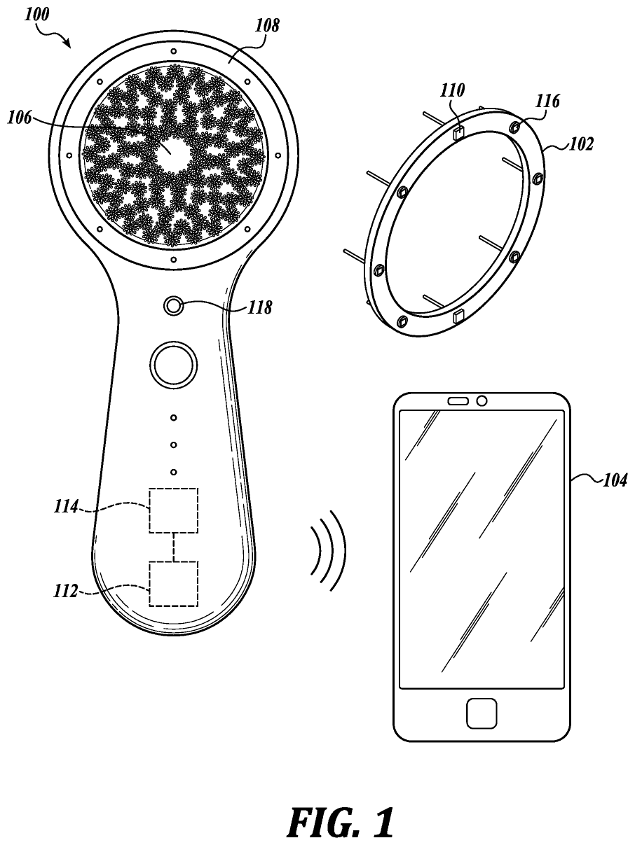

Referring to FIG. 1, a lighting system device is embodied in a hand-held brush applicator 100. The brush applicator 100 includes a brush 106 attached on an oscillating head. The oscillating head is surrounded by a plug-in connector 108. The lighting system 102 is a ring comprising one or more ambient light sensors 110 and one or more light emitting diodes 116. In one embodiment, the light sensors 110 are for measuring one or more of light temperature, light color rendering index, and light diffusion of the ambient light, and the light emitting diodes 116 are capable of producing lighting parameters over the full range of light temperature, light color rendering index, and light diffusion. The lighting system ring 102 is plugged into the connector 108. The lighting system ring 102 is therefore powered by the applicator 100, which includes a power supply. In one embodiment, the brush applicator 100 further includes a computing device 114 which is connected to a communications module 112 for communication with a computing device, such as mobile computing device 104. In one embodiment, the computing device 164 is configured to be able to interpret the signals form the light sensors 110 into one or more of the light temperature, light color rendering index, and light diffusion. Then, the computing device 114 can issue instructions for adjusting the output of the light emitting diodes 116 in order so that the combined ambient lighting conditions and the light produced by the light emitting diodes together resembles a simulated lighting condition which is produced proximate to the brush applicator 100 so that the user can see what the make-up will look like in a bathroom vanity mirror under selected simulated lighting conditions. The combined simulated lighting conditions can be verified by the light sensors 110 or else, the light emitting diodes 116 output may be further adjusted. The applicator brush 100 may include controls, such as button 118 to scroll through certain pre-selected locations, the lighting conditions of which may be simulated. Then, when a location is selected, the light emitting diodes 116 will be controlled to output light that when combined with the ambient light will result in the lighting conditions of the selected location.

In one embodiment, instead of selecting the location, the user may directly select the values of light temperature, light color rendering index, and light diffusion, and the light emitting diodes 116 will be controlled to output light that when combined with the ambient light will give the selected manually input values of lighting conditions.

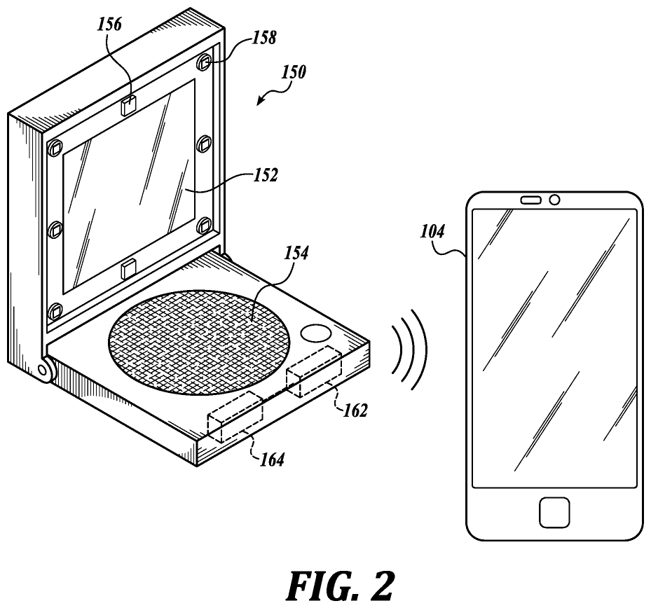

Referring to FIG. 2, a lighting system device is embodied in a mirror 152 which can be provided in a compact case 150. The compact case 150 can include a type of cosmetic make-up 154. In one embodiment, the mirror 152 is surrounded by one or more ambient light sensors156 and one or more light emitting diodes 158. In one embodiment, the light sensors 156 are for measuring one or more of light temperature, light color rendering index, and light diffusion of the ambient light, and the light emitting diodes 158 are capable of producing lighting parameters over the full range of light temperature, light color rendering index, and light diffusion. The lighting system mirror 152 can be powered by a power source in the compact case 150. In one embodiment, the compact case further includes a computing device 164 which is connected to a communications module 162 for communication with a computing device, such as mobile computing device 104. In one embodiment, the computing device 164 is configured to be able to interpret the signals form the light sensors 156 into one or more of the light temperature, light color rendering index, and light diffusion. Then, the computing device 164 can issue instructions for adjusting the output of the light emitting diodes 158 in order so that the combined ambient lighting conditions and the light produced by the light emitting diodes together resembles a simulated lighting condition which is produced proximate to the compact case 150 so that the user can see what the make-up will look like in a selected simulated lighting conditions. The combined simulated lighting conditions can be verified by the light sensors 156 or else, the light emitting diodes 158 output may be further adjusted. The compact case 150 may include controls, such as button 166 to scroll through certain pre-selected locations, the lighting conditions of which may be simulated. Then, when a location is selected, the light emitting diodes 158 will be controlled to output light that when combined with the ambient light will result in the lighting conditions of the selected location.

In one embodiment, instead of selecting the location, the user may directly select the values of light temperature, light color rendering index, and light diffusion, and the light emitting diodes 158 will be controlled to output light that when combined with the ambient light will give the selected manually input values of lighting conditions.

In one embodiment, the computing devices 114, 164 of lighting system devices 100, 150 may be configured to communicate with a mobile computing device 104 via a communications module. Accordingly, via the mobile computing device 104, the lighting system devices 114, 164 can be controlled according to instructions received through the mobile computing device 104 to produce specific simulated lighting conditions.

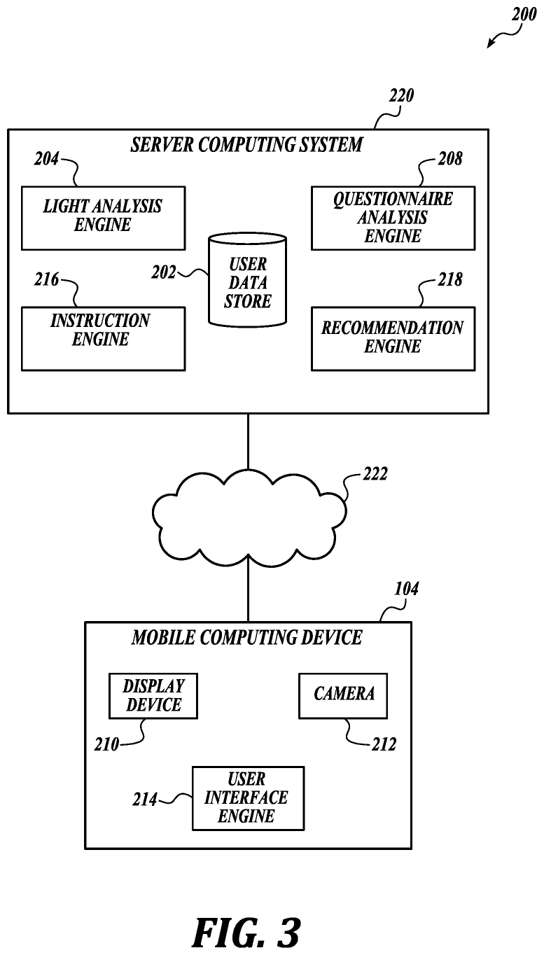

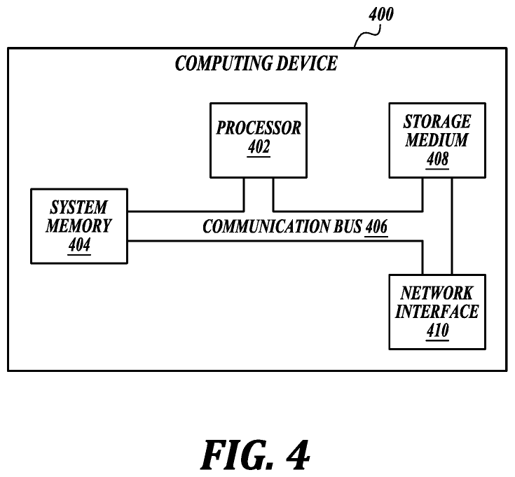

Referring to FIGS. 3 and 4 a system 200 for receiving instructions to control anyone of the lighting system devices 100, 150 is illustrated.

As already described, the lighting system devices 100, 150 further include a computing system 114, 164 with a communications module. In one embodiment, the lighting system devices 100, 150 can be controlled by downloading instructions, such as through a mobile computing device 104. The instructions downloaded from the mobile computing device 104 include lighting parameters of one or more lighting conditions. When lighting system devices 100, 150 communicate over a network, there exist possibilities for additional personalization, custom analysis, and recommendations to the user.

There are a plurality of operational options for the lighting system devices 100, 150 connected to a network. In one embodiment, the user can subscribe to a subscription service to receive different lighting conditions from a plurality of locations, which can be recorded by other users that have access to the system 200. In one embodiment, the user can be a professional that services a plurality of clients in a day, and with a subscription service, a professional can simulate virtually any lighting condition that a customer might wish to simulate. A user might receive for free generic lighting conditions with the purchase of the lighting system devices 100, 150. In one embodiment, the user can receive upgrades to the generic lighting conditions by paying for any additional lighting conditions. The user may have access to a library of other lighting conditions that are recorded by other users of the system 200. In one embodiment, all the lighting condition options become available upon purchase of the lighting system device. In one embodiment, all the lighting condition options become available to user upon the purchase of an “app” or “application” which resides on the computing device 104. In one embodiment, the user may be a professional who runs a salon, and the professional may lease certain applications. In one embodiment, the app on the mobile computing device is used to get recommendations and/or instructions. In one embodiment, the app may ask the user for certain preferences, and the user is provided with make-up recommendations, i.e., recommendations of make-up that works best for certain lighting conditions. In one embodiment, the user is provided with recommendations based on responses to a questionnaire and photos of the pre-altered brow of the user.

FIG. 3 is a block diagram that illustrates a non-limiting example embodiment of a system 200 that includes a mobile computing device 104 and a server computing system 220 according to various aspects of the present disclosure.

In one embodiment, the mobile computing device 104 may be a smartphone. In one embodiment, the mobile computing device 104 may be any other type of computing device having the illustrated components, including but not limited to a tablet computing device or a laptop computing device. In one embodiment, the mobile computing device 104 may not be mobile, but may instead by a stationary computing device such as a desktop computing device. In one embodiment, the illustrated components of the mobile computing device 104 may be within a single housing. In one embodiment, the illustrated components of the mobile computing device 104 may be in separate housings that are communicatively coupled through wired or wireless connections (such as a laptop computing device with an external camera connected via a USB cable). The mobile computing device 104 also includes other components that are not illustrated, including but not limited to one or more processors, a non-transitory computer-readable medium, a power source, and one or more communication interfaces.

As shown, the mobile computing device includes a display device 210, a camera 212, and a user interface engine 214.

In one embodiment, the display device 210 is an LED display, an OLED display, or another type of display for presenting a user interface. In one embodiment, the display device 210 may be combined with or include a touch-sensitive layer, such that a user may interact with a user interface presented on the display device 210 by touching the display. In one embodiment, a separate user interface device, including but not limited to a mouse, a keyboard, or a stylus, may be used to interact with a user interface presented on the display device 210.

In one embodiment, the user interface engine 214 is configured to present a user interface on the display device 210, including presenting at least one questionnaire for collecting information from the user. In one embodiment, the user interface engine 214 may be configured to use the camera 212 to capture images of the user in order to determine the make-up recommendations.

In one embodiment, the camera 212 is any suitable type of digital camera that is used by the mobile computing device 104. In one embodiment, the mobile computing device 104 may include more than one camera 212, such as a front-facing camera and a rear-facing camera.

In one embodiment, the server computing system 220 includes one or more computing devices that each include one or more processors, non-transitory computer-readable media, and network communication interfaces that are collectively configured to provide the components illustrated. In one embodiment, the one or more computing devices that make up the server computing system 220 may be rack-mount computing devices, desktop computing devices, or computing devices of a cloud computing service.

As shown, the server computing system 220 includes a user data store 202, a light analysis engine 204, a questionnaire engine 208, an instruction engine 216, and a recommendation engine 218.

In one embodiment, the user data store 202 is configured to store records for each user that uses the system 200. The records may include one or more ambient light conditions previously used, one or more simulated lighting conditions previously used, at least one image, responses to a questionnaire, previous instructions used for generating simulated lighting conditions, and/or other information collected or determined by the system 200.

In one embodiment, the light analysis engine 204 may be configured to process light measurements collected by the user via the light sensors in order to be able to give make-up recommendations for the given lighting conditions. In one embodiment, the light analysis engine 204 may be configured to compare the measured ambient lighting conditions to the lighting conditions of a location selected by a user.

In one embodiment, the questionnaire analysis engine 208 may be configured to receive responses to a questionnaire from the user and any light measurements and photos. The responses, light measurements, and photos to the questionnaire may determine the best make-up that is suited for the user for the specified lighting conditions.

In one embodiment, the recommendation engine 218 provides make-up recommendations to the user based on the responses to the questionnaire, including, for example the measured or selected lighting conditions.

In one embodiment, the instruction engine 216 may be configured to send the lighting conditions in terms of light temperature, light color rendering index, and light diffusion for one or more specific locations. In one embodiment, the lighting conditions are the difference between the measured ambient lighting conditions and the lighting conditions for the desired location. In one embodiment, the instructions contain the absolute value of the lighting conditions for the desired location, and the lighting device 100, 150 is able to calculate the output taking into consideration the ambient lighting conditions.

“Engine” refers to logic embodied in hardware or software instructions, which can be written in a programming language, such as C, C++, COBOL, JAVA™, PHP, Perl, HTML, CSS, JavaScript, VBScript, ASPX, Microsoft .NET™, Go, and/or the like. An engine may be compiled into executable programs or written in interpreted programming languages. Software engines may be callable from other engines or from themselves. Generally, the engines described herein refer to logical modules that can be merged with other engines, or can be divided into sub-engines. The engines can be stored in any type of computer-readable medium or computer storage device and be stored on and executed by one or more general purpose computers, thus creating a special purpose computer configured to provide the engine or the functionality thereof.

“Data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

A method for using the devices 100, 150 may, for example, begin by the user starting an app on the mobile computing device 104. The method may then present a questionnaire generated by the questionnaire analysis engine 208 on the server computing system 220. In one embodiment, the questionnaire may ask for the user to select one or more locations for which simulated lighting conditions are to be reproduced in the lighting system devices 100, 150.

In one embodiment, the responses to the questionnaire and any photos and the measured lighting conditions are transmitted to the server computing system 220. In one embodiment, the measured ambient lighting conditions are analyzed by the light analysis engine 204. The light analysis engine 204 may talk to the instruction engine 216 and the recommendation engine 218.

In one embodiment, the light analysis engine 204 talks to the recommendation engine to provide make-up recommendations to the user that would are suited best for the lighting conditions of the selected location. In making recommendations, the recommendation engine 218 may take into consideration, the lighting conditions of the selected location, the responses to the questionnaire, and any photos.

In one embodiment, the measured ambient lighting conditions processed by the commendation engine 218 to recommend make-up that works best under the measured ambient lighting conditions.

Whether using the measured ambient lighting conditions or the lighting conditions of the selected location, the recommendation engine 218 transmits the make-up recommendations to the user via the mobile computing device 104.

In one embodiment, the recommendation engine 218 may use preferences and/or feedback provided by other users with similar lighting conditions and/or responses to determine the make-up recommendations.

In one embodiment, the selected one or more locations for which simulated lighting conditions are to be reproduced and the measured ambient lighting conditions transmitted by the user are processed by the instruction engine 216. The instruction engine 216 selects from a library stored in the user data store 216, the lighting conditions corresponding to the location or locations for which simulated lighting conditions are to be reproduced. Then, the instruction engine 216, can calculate the light output of the light emitting diodes that when combined with the measured ambient lighting conditions will result in a combined simulated lighting conditions corresponding to the specified location. The instructions for achieving light temperature, color rendering index, and diffusion are transmitted to the lighting system device 100, 150 to achieve a simulated light of the selected location.

In one embodiment, instead of transmitting instructions for the light output to make up the difference between the ambient lighting conditions and the selected lighting conditions, the instructions contain the absolute value of the lighting conditions for the desired location, and the lighting device 100, 150 is able to calculate the output taking into consideration the ambient lighting conditions. In one embodiment, instead of specifying a location, the user may specify values of light temperature, color rendering index, and diffusion.

The mobile computing device 104 and the server computing system 220 communicate via a network 222. The network 222 may include any suitable networking technology, including but not limited to a wireless communication technology (including but not limited to Wi-Fi, WiMAX, Bluetooth, 2G, 3G, 4G, 5G, and LTE), a wired communication technology (including but not limited to Ethernet, USB, and FireWire), or combinations thereof.

In one embodiment, the server computing system 220 and the mobile computing device 104 include an application programming interface (API) to access location-based lighting data that may even include user-generated data (i.e. the venue/local business owners) from location and navigation applications that include maps, places, locations, and the like, such as some web-based maps. In one embodiment, there is a large-scale lighting data set collection that is accessed through integration with a pre-existing platform that already has a data set of all the real-time local businesses. For example, an Internet search engine already keeps track of when a restaurant shuts down and a new one opens in its place and allows all its local business users access to its tools to add in data about their place such as noise levels, crowdedness, accessibility features, open hours, etc. In one embodiment, the Internet search engine can also include data on indoor lighting conditions that can be accessed by either or both of the server computing system 220 and the mobile computing device 104.

In one embodiment, API integration will allow the server computing system 220 and the mobile computing device 104 to retrieve the most up-to-date location lighting condition data set for use in the lighting system.

In one embodiment, API integration will allow retrieving lighting conditions from weather providers that provides lighting conditions on day versus night or rain versus overcast, which all influence lighting conditions for people outdoors and how they'd do their make-up.

In one embodiment, one API allows to pull data for indoor lighting and a different API allows to pull data for outdoor lighting that the lighting system then uses to create the simulated lighting environment.

In one embodiment, since even homes and offices are becoming more smart and connected, lighting condition data can be pulled regarding the lighting conditions for homes and offices, such as from knowing the type of light bulbs.

FIG. 4 is a block diagram that illustrates aspects of an exemplary computing device 400 appropriate for use as a computing device of the present disclosure. While multiple different types of computing devices were discussed above, the exemplary computing device 400 describes various elements that are common to many different types of computing devices. While FIG. 4 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 400 may be any one of any number of currently available or yet to be developed devices.

In its most basic configuration, the computing device 400 includes at least one processor 402 and a system memory 404 connected by a communication bus 406. Depending on the exact configuration and type of device, the system memory 404 may be volatile or nonvolatile memory, such as read only memory (“ROM”), random access memory (“RAM”), EEPROM, flash memory, or similar memory technology. Those of ordinary skill in the art and others will recognize that system memory 404 typically stores data and/or program modules that are immediately accessible to and/or currently being operated on by the processor 402. In this regard, the processor 402 may serve as a computational center of the computing device 400 by supporting the execution of instructions.

As further illustrated in FIG. 4, the computing device 400 may include a network interface 410 comprising one or more components for communicating with other devices over a network. Embodiments of the present disclosure may access basic services that utilize the network interface 410 to perform communications using common network protocols. The network interface 410 may also include a wireless network interface configured to communicate via one or more wireless communication protocols, such as WiFi, 2G, 3G, LTE, WiMAX, Bluetooth, Bluetooth low energy, and/or the like. As will be appreciated by one of ordinary skill in the art, the network interface 410 illustrated in FIG. 4 may represent one or more wireless interfaces or physical communication interfaces described and illustrated above with respect to particular components of the computing device 400.

In the exemplary embodiment depicted in FIG. 4, the computing device 400 also includes a storage medium 408. However, services may be accessed using a computing device that does not include means for persisting data to a local storage medium. The storage medium 408 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 404 and storage medium 408 depicted in FIG. 4 are merely examples of computer-readable media.

Suitable implementations of computing devices that include a processor 402, system memory 404, communication bus 406, storage medium 408, and network interface 410 are known and commercially available. For ease of illustration and because it is not important for an understanding of the claimed subject matter, FIG. 4 does not show some of the typical components of many computing devices. In this regard, the computing device 400 may include input devices, such as a keyboard, keypad, mouse, microphone, touch input device, touch screen, tablet, and/or the like. Such input devices may be coupled to the computing device 400 by wired or wireless connections including RF, infrared, serial, parallel, Bluetooth, Bluetooth low energy, USB, or other suitable connections protocols using wireless or physical connections. Similarly, the computing device 400 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

The embodiments of the invention in which an exclusive property or privilege is claimed are defined as follows:

1. A lighting system device, comprising:
a light sensor to measure ambient lighting conditions;
a light source;
one or more computing devices allowing selecting a location other than ambient location;
one or more computing devices that compare the ambient lighting conditions to the lighting conditions of the selected location; and
one or more computing devices that control the output of the light source to produce lighting conditions that when combined with the ambient lighting conditions simulate the lighting conditions of the selected location.

2. The lighting system device of claim 1, wherein the lighting conditions include one of light temperature, light color rendering index, and light diffusion;

3. The lighting system device of claim 1, further comprising a mirror, a brush, or a compact case.

4. The lighting system device of claim 1, wherein the light source includes one or more light emitting diodes.

5. The lighting system device of claim 1, further comprising a communications module.

6. The lighting system device of claim 1, wherein the location is selected from at least one of indoor, outdoor, day, night, stage, non-stage, an entertainment venue.

7. A computer-implemented method of simulating lighting conditions, the method comprising:
receiving, by the computing device, a selection for a location;
receiving, by a computing device, measured ambient lighting conditions;
receiving, by the computing device, lighting conditions of the selected location; and
providing, by the computing device, instructions for a lighting system device, wherein the instructions control a light source to output light that when combined with the ambient lighting conditions simulate the lighting conditions of the selected location.

8. The computer-implemented method of claim 7, wherein the instructions control at least one of light temperature, light color rendering index, and light diffusion.

9. The computer-implemented method of claim 7, further comprising providing, by the computing device, a comparison of the measured ambient lighting conditions to the lighting conditions of the selected location.

10. The computer-implemented method of claim 7, further comprising providing, by the computing device, cosmetic make-up recommendations that are best suited for the measured ambient lighting conditions.

11. The computer-implemented method of claim 7, further comprising providing, by the computing device, cosmetic make-up recommendations that are best suited for the lighting conditions of the selected location.

12. A computing device, comprising at least a memory and processor, configured to:
receive a selection of a location;
receive measured ambient lighting conditions;
receive lighting conditions of the selected location; and
provide instructions for a lighting system device, wherein the instructions control a light source to output light that when combined with the ambient lighting conditions simulate the lighting conditions of the selected location.

13. The computing device of claim 12, wherein the instructions control at least one of light temperature, light color rendering index, and light diffusion.

14. The computing device of claim 12, wherein the computing device is further configured to compare the measured ambient lighting conditions to the lighting conditions of the selected location.

15. The computing device of claim 12, wherein the computing device is further configured to provide cosmetic make-up recommendations that are best suited for the measured ambient lighting conditions.

16. The computing device of claim 12, wherein the computing device is further configured to provide cosmetic make-up recommendations that are best suited for the lighting conditions of the selected location.

17. The computing device of claim 12, comprising an application programming interface to retrieve the lighting conditions.

18. A system, comprising:
a questionnaire analysis engine including computational circuitry configured to:
provide a selection of a location;
a light analysis engine including computational circuitry configured to:
receive measured ambient lighting conditions and lighting conditions of the selected location; and
an instruction engine including computational circuitry configured to:
provide instructions for a lighting system device, wherein the instructions control a light source to output light that when combined with the ambient lighting conditions simulate the lighting conditions of the selected location.

19. The system of claim 18, wherein the instructions control at least one of light temperature, light color rendering index, and light diffusion.

20. The system of claim 18, wherein the light analysis engine includes computational circuitry configured to:
compare the measured ambient lighting conditions to the lighting conditions of the selected location.

21. The system of claim 18, further comprising a recommendation engine including computational circuitry configured to:
provide cosmetic make-up recommendations that are best suited for the measured ambient lighting conditions.

22. The system of claim 18, further comprising a recommendation engine including computational circuitry configured to:
provide cosmetic make-up recommendations that are best suited for the lighting conditions of the selected location.

23. The system of claim 18, comprising an application programming interface to retrieve the lighting conditions.
